(19) United States
(12) Patent Application Publication
(10) Pub. No.: US 2007/0030863 A1
(43) Pub. Date: Feb. 8, 2007

(54) Digital data receiving apparatus

(76) Inventor: Darren Fawcett, Shipley (GB)

Correspondence Address: HEAD, JOHNSON & KACHIGIAN, 228 W 17TH PLACE, TULSA, OK, 74119, US

(21) Appl. No.: 11/496,666

(22) Filed: Jul. 31, 2006

(30) Foreign Application Priority Data
Jul. 30, 2005 (GB) 0515717.7

(51) Int. Cl. H04J 3/18

(52) U.S. Cl. 370/477

(57) ABSTRACT

The invention relates to the provision of apparatus and a method for use in the selective distribution of selected data streams from a plurality of data streams that have been received at a particular location. The data is transmitted typically via a satellite transmission system and is received at each receiving premises via at least on Low Noise Block connected to at least one broadcast data receiver. A satellite multiplexer/channel stacker apparatus is provided, and the invention provides for the detection and comparison of the values of at least one characteristic of at least two data streams in the stacker apparatus. If the difference between the values is greater than a predetermined level, a parameter of at least one of the data streams is adjusted until the difference falls below the predetermined level. This allows a reduction in data errors and reduces the degradation of the system implementation margin.

### CROSS-REFERENCE TO RELATED APPLICATION

This application claims priority to British Patent Application No. 0515717.7 filed 30 Jul. 2005.

### STATEMENT REGARDING FEDERALLY SPONSORED RESEARCH OR DEVELOPMENT

Not Applicable

### THE NAME OF THE PARTIES TO A JOINT RESEARCH AGREEMENT

Not Applicable

### INCORPORATION BY REFERENCE OF MATERIAL SUBMITTED ON A COMPACT DISC

Not Applicable

### REFERENCE TO A MICROFICHE APPENDIX

Not Applicable

### BACKGROUND OF THE INVENTION

### FIELD OF THE INVENTION

The invention to which this application relates is digital data receiving apparatus and particularly, although not necessarily exclusively, apparatus for receiving digital data that has been transmitted via satellite from a broadcast location, or head end, to a plurality of premises for the generation of television, radio and/or other services. Each of the premises includes receiver apparatus, typically called a set top box or Broadcast Data Receiver (BDR). This apparatus receives the data, decodes the same as required and then allows the transmission of audio and/or video, typically via a television set or display screen and speakers connected to the BDR.

Conventionally, the digital data is transmitted in a number of transport streams, each stream transmitted at a frequency with a given frequency range and received at each premises using a satellite aerial (or dish) that has, mounted therein, a receiving horn and a Low Noise Block (LNB). This apparatus, that is typically mounted externally of the premises and is directed towards the satellite from that the data is transmitted, enables the transfer of the data to the broadcast data receiver within the premises which then processes the received data and decodes the same to allow the required television, radio and/or other services to be provided to the user via a display screen and speakers connected to the receiver.

Conventionally a series of data streams are transmitted in each transport stream within a given frequency range (IF), each data stream carrying data to allow one or more television or radio channels to be generated should they be selected by the user via the BDR. Thus, the combination of data streams makes up the total number of channels and services that are available for user selection. These data streams are typically received from the LNB to the BDR along one cable connection. This requires one cable to be provided for each IF and LNB.

However, with the increasing proliferation of channels that could be available to users and also the increase in broadcast data receivers that may be provided within a premises, it is being found that more than one LNB and, hence, more than one cable is required. However, as each broadcast data receiver can typically only decode one user requested channel at any one time from one of the LNB's or IF ranges, it will be appreciated that at any given time several of the cables are redundant. The current scheme is, therefore, uneconomic, as in practice only one of the plurality of cables is being used to carry data to the receiver at any given time.

In order to overcome this problem, it is already known to multiplex the data streams in a multiplex/channel stacker and then transmit the required data stream at any given time along a single cable in response to the user selection at that time. The satellite multiplex/channel stacker operates by up/down converting the received data streams and multiplexing those streams onto one cable.

The received data is typically within the frequency range 950-2150 MHz. In this case only one cable connection is required between the LNB and broadcast data receiver. However, a problem that is experienced with this multiplex system is that there are inherent data losses and errors that can be caused by any or any combination of cable losses, incorrect satellite aerial dish alignments, connector mismatches. As a result, the data streams that are multiplexed may not be at the same amplitude level. The difference in amplitude level can cause interference (IP2/IP3) to the desired data stream signal and can degrade the implementation margin of the signal that, in turn, results in signal loss and/or picture break-up when the data is subsequently decoded and processed by the broadcast data receiver.

### BRIEF SUMMARY OF THE INVENTION

The aim of the present invention is to provide apparatus and a method that reduces the effect of the data impairment in the received data stream, thus, reducing the degradation upon the system implementation margin that results in better coverage and data signal robustness at the broadcast data receiver location when a data stream signal multiplex/stacker arrangement is utilized.

In a first aspect of the invention, there is provided a method for the provision of selected received data streams to a broadcast data receiver from a series of stacked received IF digital data stream signals having been transmitted from a data broadcast location and received via one or more Low Noise Blocks(LNB's) at a receiving location. The method comprising the steps of receiving a series of data streams at frequencies within a frequency range at the one or more LNB's, passing the data streams into a satellite multiplexer/channel stacker apparatus intermediate the LNB's and a broadcast data receiver, and selectively transmitting data from one or more of the data streams to the broadcast data receiver via a cable connection for further data processing and decoding in response to a user selection made via the broadcast data receiver. The method further includes the steps of detecting the value of at least one known characteristic of at least two of the data streams in the stacker apparatus, comparing the characteristic values and if the difference between the values exceeds a predetermined level, a parameter of at least one of the first and second data streams is altered. The value of the at least one known characteristic is compared again, and these steps repeated until the difference between the values falls below the predetermined level, at which time, the multiplexer/channel stacker is deemed to be operating correctly.

Preferably, the method steps are performed upon installation and initialization of the LNB, the broadcast data receiver and the stacker apparatus.

In one embodiment, the compared characteristic is the signal level and the parameter value that is altered is the amplitude gain control (AGC) that is repeatedly altered until the difference between the signal level values for each of the data streams falls below the predetermined level which, in one embodiment is set such that the values for each of the data streams are being compared are substantially the same.

In an alternative embodiment, the characteristic that is compared is the Bit Error Rate (BER) of each of the data streams being compared and the parameter value that is altered is the AGC of at least one of the data streams. Once again, it is preferred that the steps are repeated until the BER's of each of the data streams are substantially equal.

Preferably, when assessing the characteristic, the value of the characteristic of the data stream that has the higher frequency data stream should be measured first, as this will tend to have the poorest signals due to the likelihood of a lower signal strength at the higher frequency data stream.

In a further aspect of the invention, there is provided apparatus for receiving, stacking and selectively distributing a series of IF digital data streams transmitted from a data broadcast location and received at a receiving location. The apparatus includes one or more low noise blocks, a satellite multiplexer/channel stacker apparatus and at least one broadcast data receiver. The LNB's, stacker apparatus and broadcast data receiver being connected by at least one cable connection along which data can be transmitted to the broadcast data receiver from the stacker apparatus in response to a user selection made via the broadcast data receiver. The apparatus further includes control means to detect the values of at least one known characteristic of at least two of the data streams held in the stacker apparatus, comparison means to compare the values and adjustment means that are operated if the difference between the values exceeds a predetermined level the adjustment means provided to allow adjustment of a parameter of at least one of the first and second data streams.

In one embodiment the control means, comparison means, and adjustment means are utilized at the time of installation and initialization of the apparatus.

In a further aspect of the invention, there is provided a method for controlling the stacking of a series of IF digital data signals received from a broadcast location. The method comprising the steps of receiving a series of data streams at frequencies within a frequency range via one or more Low Noise Blocks (LNB's), passing the data streams into a satellite multiplexer/channel stacker and selectively transmitting data from one or more of the data streams in response to a user selection to a receiver for further data processing and decoding. The method further includes the step for the multiplexer/channel stacker, of assessing at least one known characteristic of at least two of the data streams, comparing the characteristic values and if a difference value exceeds a predetermined value, a value of a parameter of at least one of the first and second data streams is altered, the characteristics compared again and these steps repeated until the difference value falls below the predetermined value whereupon the multiplexer/channel stacker is deemed to be installed correctly. Preferably, the steps are performed upon initialization of the apparatus.

### BRIEF DESCRIPTION OF THE SEVERAL VIEWS OF THE DRAWINGS

An embodiment of the invention will now be described with reference to the accompanying drawings.

FIG. 1 illustrates in schematic fashion the apparatus in accordance with one embodiment of the invention.

FIG. 2 illustrates the receipt of data streams at different frequencies and the collation of the same in a multiplexer/channel stacker.

### DETAILED DESCRIPTION OF THE INVENTION

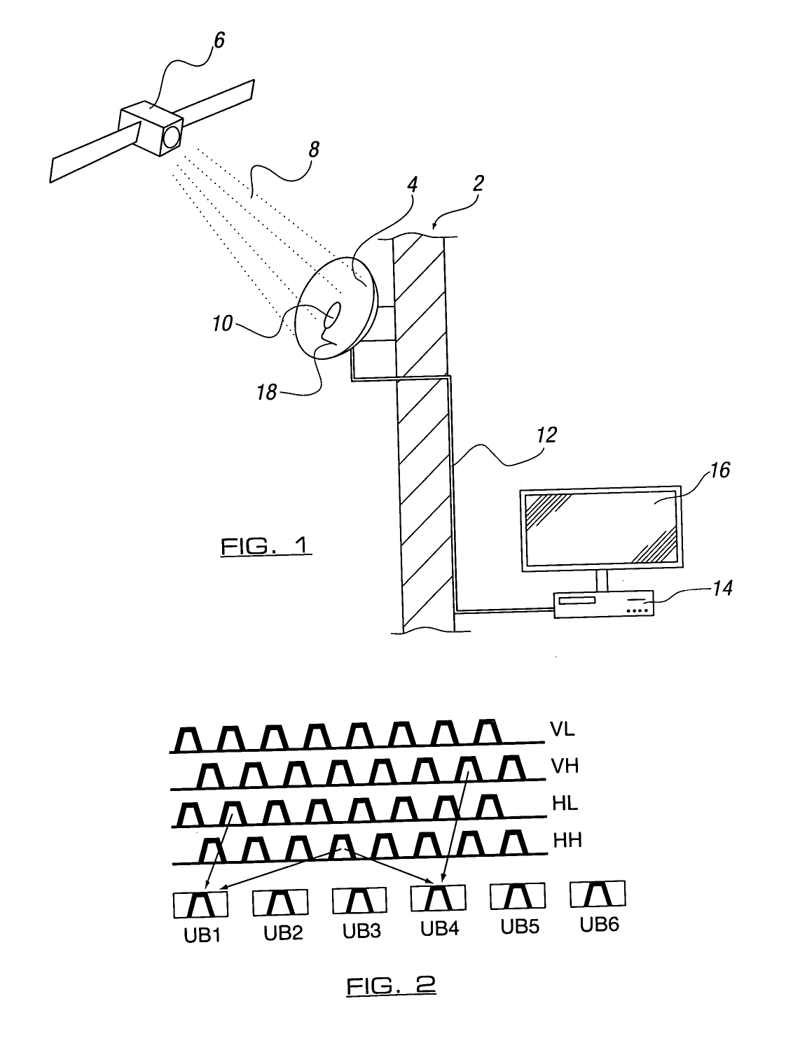

Referring firstly to FIG. 1, there is illustrated in schematic fashion apparatus to which this application relates. The apparatus is provided at a receiving location 2, such as a domestic premises. It should be appreciated that a plurality of receiving locations are provided at which the current invention can be repeated. Externally of the premises, there is provided a satellite receiving aerial 4 that is located so as to receive data 8 being transmitted from one or more remote satellites. The aerial 4 is provided with one or more Low Noise Blocks (LNB) 10 that serve to collect the received data and then send the received data along cable connection 12 internally of the premises to one or more broadcast data receivers 14. The broadcast data receiver (BDR) 14 is provided to decode the data and then process the same into a condition to allow video and/or audio to be generated to a viewer, typically via a television set 16 connected to the same. When the user wishes to view a particular channel he/she can choose this through the BDR. The BDR then requests the appropriate data from the LNB that results in the sending of the appropriate data stream from a multiplexer/stacker apparatus 18 positioned intermediate the LNB's and broadcast data receiver. The provision of the stacker apparatus 18 overcomes the need for all of the data streams to be transmitted to the BDR at any given time and, therefore, avoids the need for a cable connection to be provided for each LNB.

FIG. 2 illustrates how it is efficient to multiplex received data stream signals in a multiplex/channel stacker and selectively transmit a data stream along a single cable connection to the broadcast data receiver in response to a user demand along one cable. Conventionally, all of the frequencies from one LNB were transmitted along a single cable, and one such scheme is illustrated in FIG. 2 where the data signals from the different polarizations VL, VH, HL and HH and different bands UB1, UB2, UB3, UB4, UB5 and UB6 for an LNB are multiplexed to be passed along a cable for that LNB. However, this meant that for each LNB a separate cable was required. In order to overcome this, the multiplex stacker 18 was provided as previously described. However, due to cable losses, dish alignments, connector mismatches and the like, the multiplexed signals were frequently not all at the same amplitude level. This invention reduces the implementation loss caused by the multiplexed signals IP2 and IP3 interference that can occur as illustrated below.

However, it is also known that with an amplitude level slope i.e. data streams having different amplitude levels on the cable, such that the slope is 15 dB (the delta between the wanted and the unwanted is 15 dB) that the overall implementation margin loss can be as much as 1.2 dB that is considerably greater than when there is no difference in amplitude level. This represents the problem currently experienced in multiplexer/channel stackers where there is a difference in amplitude levels of the data stream signals held therein. This loss of 1.2 dB can result in degradation of the service, such as signal loss, severe BER resulting in macro blocking (picture break-up).

In a first embodiment to solve this problem, typically at the time of installation of the apparatus, the following method can be performed:

1. Tune to a first data stream (IF1);

2. Store the signal level for IF1;

3. Tune to a second data stream (IF2);

4. Store the signal level for IF2; and

5. Compare and adjust the respective parameter AGC values

If the signal level for IF1>signal level for IF2,
   Adjust AGC's until signal levels equal
If signal levels for IF1<signal levels for IF2,
   Adjust AGC's until signal levels equal.

Thus, in this case, the steps are repeated until the predetermined level of difference between the signal strength values for the first and second data streams is effectively zero.

An alternative method is to measure the bit error rate (BER) of each of the selected data streams:

1. Tune to first data stream IF 1;

2. Store the bit error rate value (BER1) for IF1;

3. Tune to second data stream IF2;

4. Store the bit error rate value (BER2) for IF2; and

5. Refer to a predetermined bit error rate (in this case 2e-04)

IF BER2>2e-04
Increase AGC1 to generate a new value BER2-X
IF BER2_X>BER2
Decrease AGC1
   And then repeat the procedure until BER1˜BER2.

The aim is, therefore, to achieve a situation in performance where there is no amplitude slope, i.e. with all signals at the same amplitude level, as this therefore reduces greatly the contribution to the overall system implementation margin to a relatively low level such as 0.1 dB.

Increased robustness to signal impairments when using satellite multiplexes/channel stackers is thus achieved by using either of these embodiments described above as the data streams in the stacker apparatus now have effectively the same level of the critical characteristics. This reduces the likelihood of loss of signal and/or picture breakup and thereby improves the quality of the service to the user while, at the same time, allowing the effective removal of redundancy in the hardware required to provide the plurality of data streams in that a single cable connection can still be used.

While the invention has been described with a certain degree of particularly, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

1. A method for the provision of selected received data streams to a broadcast data receiver from a series of stacked received IF digital data stream signals having been transmitted from a data broadcast location and received via one or more low noise blocks at a receiving location, said method comprising the steps of:
receiving a series of data streams at frequencies within a frequency range at the one or more low noise blocks;
passing the data streams into a satellite multiplexer/channel stacker apparatus intermediate the low noise blocks and a broadcast data receiver and selectively transmitting data from one or more of the data streams to the broadcast data receiver via a cable connection for further data processing and decoding in response to a user selection made via the broadcast data receiver;
detecting the value of at least one known characteristic of at least two of the data streams in the stacker apparatus;
comparing the characteristic values and if the difference between the values exceeds a predetermined level, a parameter of at least one of the first and second data streams is altered; and
the value of the at least one known characteristic compared again and these steps repeated until the difference between the values falls below the predetermined level, at which time, the multiplexer/channel stacker is deemed to be operating correctly.

2. A method according to claim 1 wherein the method steps are performed upon installation and initialization of the low noise blocks, broadcast data receiver, and stacker apparatus.

3. A method according to claim 1 wherein the characteristic values which are compared is the value of the signal level for each of the data streams.

4. A method according to claim 3 wherein the parameter value that is altered is the amplitude gain control of one of the data streams.

5. A method according to claim 1 wherein the characteristic values that are compared is the bit error rate of each of the data streams.

6. A method according to claim 5 wherein the parameter value which is altered is the amplitude gain control of at least one of the data streams.

7. A method according to claim 1 wherein the value of the characteristic of the data stream at the highest frequency of those being compared is measured first.

8. A method according to claim 1 wherein the steps are repeated and the parameter adjusted until the values of the characteristic are substantially equal.

9. Apparatus for receiving, stacking and selectively distributing a series of IF digital data streams transmitted from a data broadcast location and received at a receiving location, said apparatus comprising:
one or more low noise blocks, a satellite multiplexer/channel stacker apparatus and at least one broadcast data receiver, the low noise blocks, stacker apparatus and broadcast data receiver connected by at least one cable connection along which data can be transmitted to the broadcast data receiver from the stacker apparatus in response to a user selection made via the broadcast data receiver;
control means to detect the values of at least one known characteristic of at least two of said data streams held in the stacker apparatus;
comparison means to compare the values; and
adjustment means which are operated if the difference between the values exceeds a predetermined level, said adjustment means provided to allow adjustment of a parameter of at least one of the said first and second data streams.

10. Apparatus according to claim 9 wherein said control means, comparison means and adjustment means are utilized at the time of installation and initialization of said apparatus.
